(19) United States
(12) Patent Application Publication
(10) Pub. No.: US 2015/0296719 A1
(43) Pub. Date: Oct. 22, 2015

(54) POWER TOOL WITH MAGNETIC BLADE COUPLING

(71) Applicant: BLACK & DECKER INC., Newark, DE (US)

(72) Inventors: Brent A. KUEHNE, Red Lion, PA (US); Ashok Samuel BASKAR, Lutherville, MD (US)

(73) Assignee: BLACK & DECKER INC., Newark, DE (US)

(21) Appl. No.: 14/255,293

(22) Filed: Apr. 17, 2014

(51) Int. Cl. A01G 3/053

(52) U.S. Cl. CPC A01G 3/053

(57) ABSTRACT

Various exemplary embodiments relate to a power tool including: a housing; a selectively actuable motor including a rotary output; a rotary drive element arranged in operative contact with the rotary output of the motor and including a drive pin; a removable blade assembly having a stationary blade and a moving blade in operative contact with the drive pin, wherein movement of the drive pin is translated into movement of the moving blade; a blade holder operable to selectively lock the stationary blade in an aligned position with respect to the housing; and a magnet positioned to contact the stationary blade when the stationary blade occupies the aligned position and hold the stationary blade in the aligned position. Various embodiments relate to a related transmission including similar features including a magnet positioned to contact a stationary blade when the stationary blade occupies the aligned position.

### CROSS-REFERENCE TO RELATED APPLICATIONS

The present application is related to U.S. patent application Ser. No. 11/220,472, filed on Sep. 7, 2005, the entire disclosure of which is hereby incorporated herein for all purposes.

### TECHNICAL FIELD

Various exemplary embodiments disclosed herein relate generally to power tools and, more particularly but not exclusively, to handheld power tools having removable blades for trimming and cutting vegetation.

### BACKGROUND

Known power tools having interchangeable blades are cumbersome and potentially dangerous to manipulate. For example, U.S. Pat. No. 3,959,878 to Irelan et al., discloses a convertible portable electric tool having interchangeable tool pieces. Each of the interchangeable tool pieces include two parts, a stationary element and a moving element, which are pivoted together at a pin. The stationary element includes a comb of teeth and, likewise, the moving element includes a comb of teeth. The rearward end of the moving element includes an elongated opening for receipt of a drive member. The drive member is rotated by a gear and the resulting circular movement oscillates the moving element about the pivot pin. As a result, the stationary element and the moving element lap one another to cut grass between the teeth upon oscillation of the moving element.

Before attaching a tool piece assembly to the power housing, the user must first rotate the drive member to a predetermined position, such as a top dead center position. Similarly, the user must manually orient the moving element into a predetermined position with respect to the stationary element. After completing these preliminary steps, the drive member can be fitted within the elongated opening of the moving element upon bringing the stationary element into proper registry relative to the power housing. Once the stationary tool element is brought into proper registry and located over guide posts, additional means are provided to maintain the tool piece releasably secured against the housing.

Accordingly, the attachment of tool pieces to a power housing as disclosed by Irelan et al. is a cumbersome process requiring various manual alignment steps to be performed by the user with respect to both the tool piece and the power housing. Generally, known power tools do not provide fool-proof mechanisms to allow easy, safe, and automatic alignment and attachment of cutting elements. Instead, users are required to spend time handling and adjusting cutting blades and other movable parts until precise alignments are achieved before a cutting element can be properly attached. Not only is this time consuming, but the user is also exposed to sharp cutting surfaces and powered moving parts in the process.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various embodiments relate to a power tool including: a housing; a selectively actuable motor including a rotary output; a rotary drive element arranged in operative contact with the rotary output of the motor and including a drive pin; a removable blade assembly having a stationary blade and a moving blade in operative contact with the drive pin, wherein movement of the drive pin is translated into movement of the moving blade; a blade holder operable to selectively lock the stationary blade in an aligned position with respect to the housing; and a magnet positioned to contact the stationary blade when the stationary blade occupies the aligned position and hold the stationary blade in the aligned position.

Various embodiments relate to power tool transmission including: a housing; an interface operable to engage a rotary output of a motor; a gearbox operatively connected to the interface to transfer the rotary output to a drive plate including a drive pin; a blade holder operable to selectively lock a stationary blade of a removable blade assembly in an aligned position with respect to the housing; and a magnet positioned to contact the stationary blade when the stationary blade occupies the aligned position.

Various embodiments are described wherein the magnet is movable with respect to the housing such that during attachment of the removable blade assembly to the housing, the magnet is permitted to extend toward the stationary blade under the force of magnetic attraction, away from an initial magnet position occupied by the magnet when the blade holder locks the stationary blade.

Various embodiments are described wherein the magnet is spring biased to return to the initial magnet position.

Various embodiments additionally include a magnet holder including an open frame configured to receive the magnet such that the magnet is exposed on at least one side of the frame.

Various embodiments are described wherein the magnet includes at least one ledge created by an increase in at least one dimension of the magnet, wherein the at least one step is positioned to abut an interior face of the open frame and thereby resist passage of the magnet through the frame.

Various embodiments are described wherein the magnet is at least 0.5 millimeters proud with respect to a blade-facing side of the open frame.

Various embodiments additionally include an alignment feature matching a geometric feature of the removable blade assembly and the magnet at least partially pulls the stationary blade toward alignment with the alignment feature during attachment of the removable blade assembly to the housing.

Various embodiments are described wherein the alignment feature includes at least one edge having a shape that is complementary to a portion of an outer edge of the removable blade assembly.

Various embodiments are described wherein the blade holder is a removable cover and the at least one edge is a portion of a rail arranged to mate with a complementary hook of the removable cover.

Various embodiments are described wherein the alignment feature includes at least one projection having a shape that is received within an interior recess disposed within the removable blade assembly.

Various embodiments are described wherein the blade holder includes a removable cover configured to mate with the housing, wherein when the cover is mated with the housing while the blade in the aligned position, the blade is disposed between the cover and the housing and is prevented from moving out of the aligned position.

### BRIEF DESCRIPTION OF THE DRAWINGS

In order to better understand various exemplary embodiments, reference is made to the accompanying drawings, wherein:

FIG. 1 illustrates a perspective view of an exemplary power tool transmission;

FIG. 2 illustrates a left side view of the power tool transmission;

FIG. 3 illustrates a right side view of the power tool transmission;

FIG. 4 illustrates a front end view of the power tool transmission;

FIG. 5 illustrates a top view of the power tool transmission;

FIG. 6 illustrates a rear end view of the power tool transmission;

FIG. 7 illustrates a bottom view of the power tool transmission;

FIG. 8 illustrates a bottom view of the power tool transmission with an exemplary bottom cover removed;

FIG. 9 illustrates a perspective view of the power tool transmission assembled with an exemplary removable blade assembly;

FIG. 10 illustrates a perspective view of a power tool transmission with the bottom cover removed and the removable blade assembly in an aligned position for locking the removable blade assembly to the power tool transmission;

FIG. 11 illustrates a perspective view of an exemplary magnet assembly;

FIG. 12 illustrates a second perspective view of the magnet assembly;

FIG. 13 illustrates an exploded view of the magnet assembly;

FIG. 14 illustrates a rear view of the power tool transmission in cross section taken across line A-A;

FIG. 15 illustrates a cutaway perspective view of the power tool transmission;

FIG. 16 illustrates a cutaway perspective view of the power tool transmission with an exemplary removable blade assembly in an aligned position;

FIG. 17 illustrates a bottom view of an exemplary power unit for use with the power tool transmission;

FIG. 18 illustrates a perspective view of the power tool transmission assembled with the removable blade assembly and the power unit;

FIG. 19 illustrates a rear view of the power tool transmission in cross section taken across line B-B;

FIG. 20 illustrates a top view of the power tool transmission in cross section taken across line C-C;

FIG. 21 illustrates a rear view of the power tool transmission in cross section taken across line B-B as one of the buttons is held in an engaged position;

FIG. 22 illustrates a cutaway perspective view of the power tool transmission showing the gearcase;

FIG. 23 illustrates a cutaway perspective view of the power tool transmission showing a single stage reduction gear set;

FIG. 24 illustrates a cutaway perspective view of the power tool transmission showing a dual stage reduction gear get;

FIG. 25 illustrates a perspective view of an exemplary drive plate assembly;

FIG. 26 illustrates an exploded view of the drive plate assembly;

FIG. 27 illustrates a perspective view of an exemplary shrub blade assembly; and

FIG. 28 illustrates a perspective view of an exemplary shear blade assembly.

To facilitate understanding, identical reference numerals have been used to designate elements having substantially the same or similar structure or substantially the same or similar function.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or,” as used herein, refers to a non-exclusive or (i.e., and/or), unless otherwise indicated (e.g., “or else” or “or in the alternative”). Additionally, the various embodiments described herein are not necessarily mutually exclusive and may be combined to produce additional embodiments that incorporate the principles described herein.

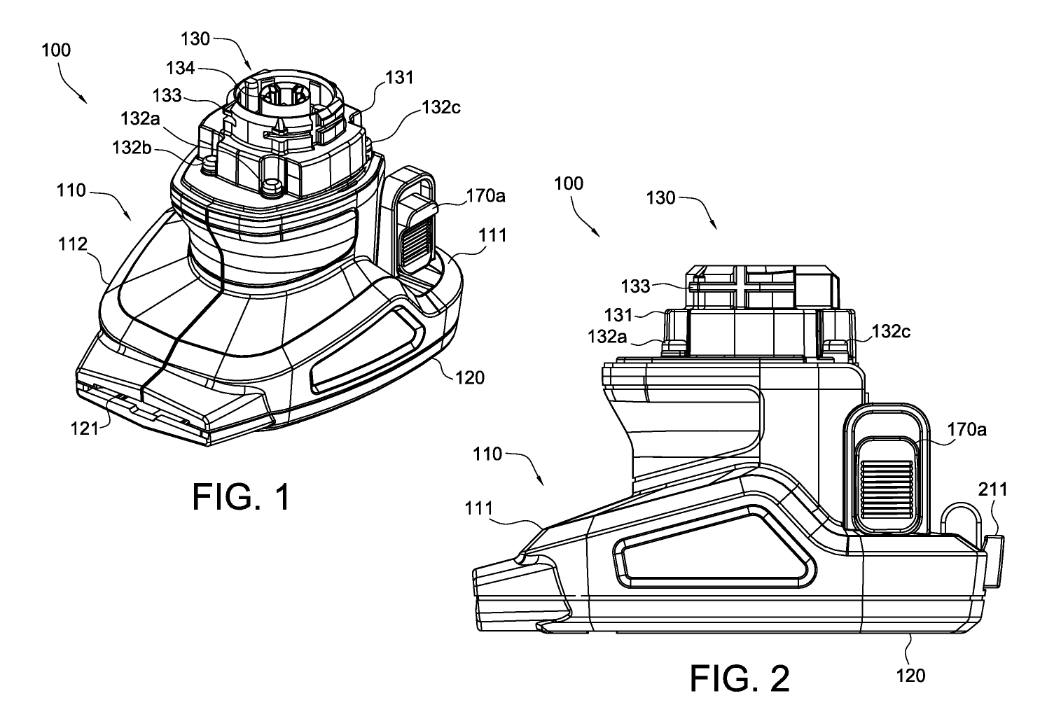

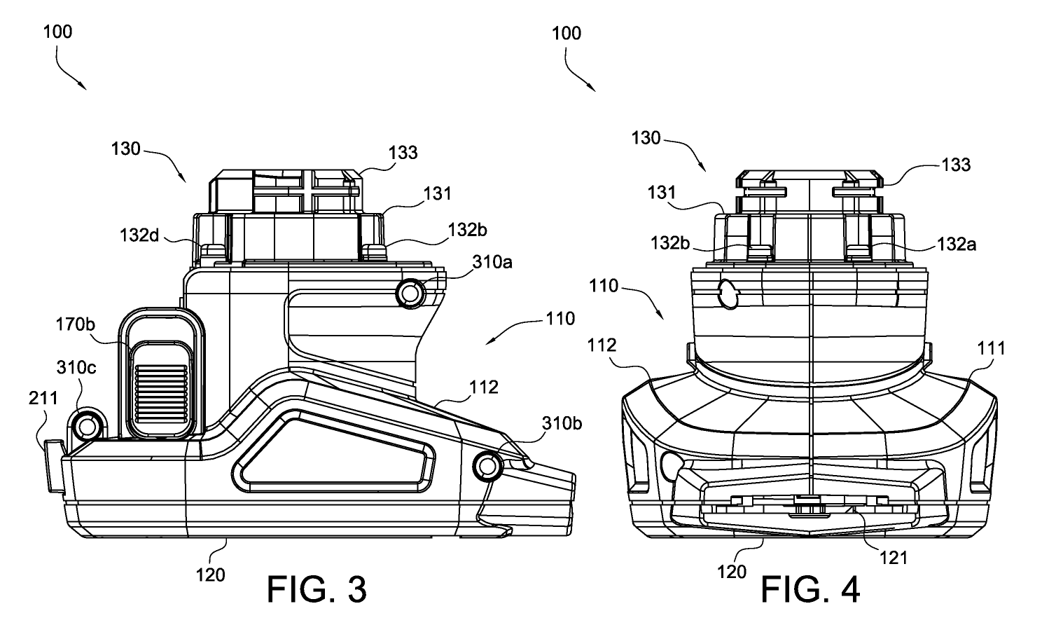

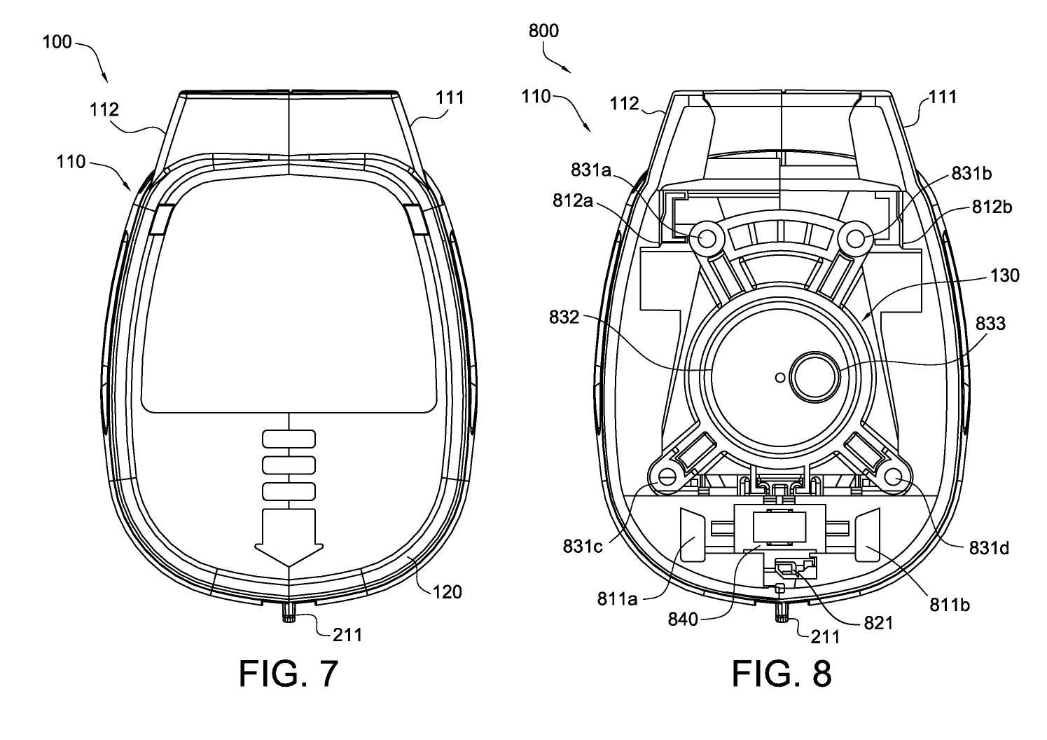

FIGS. 1-7 illustrate multiple views of an exemplary power tool transmission 100 for use in conjunction with a power unit not shown) and blade assembly 950 to form a power tool device for cutting and trimming vegetation. The power tool device may be a handheld unit for cutting grass, weeds, and other types of vegetation around a house or business, or any other location where unwanted growth is found. The power tool device may be part of a system or kit that allows a user to perform various different cutting functions using a common power tool transmission 100. The power tool system may include a plurality of interchangeable blade carrier assemblies (not shown) that may be releasably attached to the power tool transmission 100.

The exemplary transmission 100 includes a housing 110, a bottom cover 120, and a gearcase 130. In the example shown, the housing 110 is formed of a left housing shell 111 and a right housing shell 112 that are attached to each other via three housing screws 310a-c. It will be appreciated that various alternative arrangements may be utilized to form the housing 110 including a unitary shell, additional shells or other parts, and additional or alternative attachment methods.

The bottom cover 120 is shown attached to the bottom of the housing and is removable therefrom. For example, in various embodiments, the housing 110 includes a bottom cover release button 211 attached to a bottom cover hook 813 that engages with a receiving slot (not shown) on the top surface of the bottom cover 120 to hold the cover in place. In some such embodiments, the cover additionally includes four rail hooks (not shown) that engage rails 811a-b, 812a-b on the bottom surface of the housing 110. As such, the bottom cover 120 may be removed from the housing 110 by first sliding the bottom cover release button 211 to disengage that bottom cover hook from the bottom cover 120 and then sliding the bottom cover 120 toward the rear of the transmission 100 to disengage the rail hooks from the housing rails. Various alternative structures for retaining the bottom cover 120 on and releasing the bottom cover 120 from the housing 110 will be apparent.

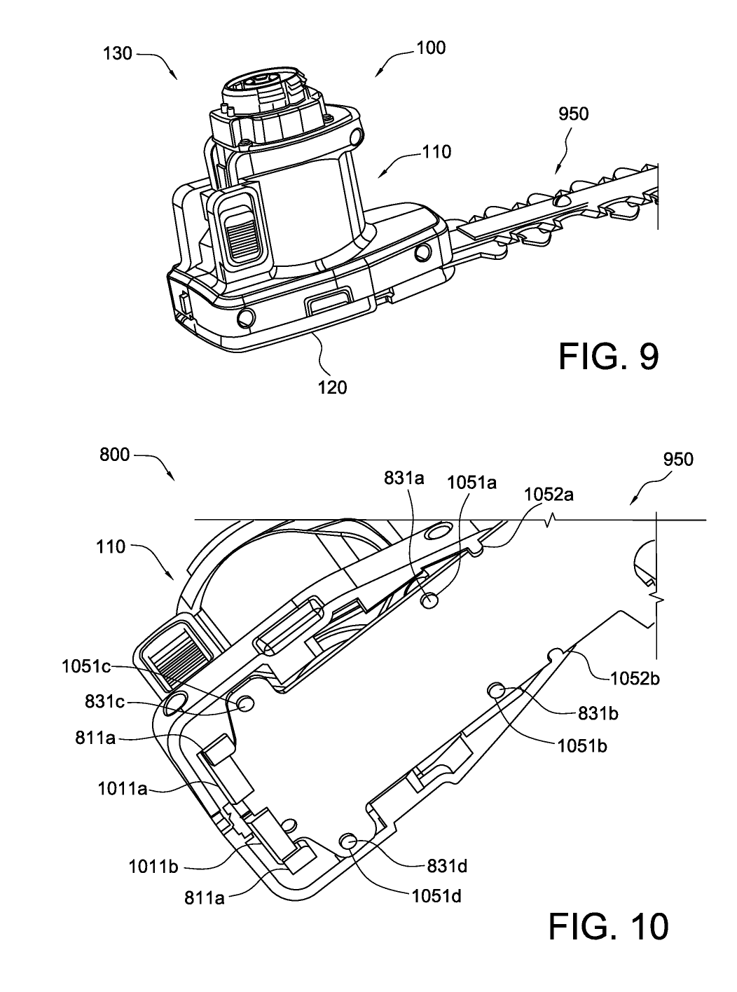

The housing 110 and bottom cover 120 form a cavity therebetween that is accessible via a blade opening 121 formed by a separation between the housing 110 and the bottom cover 120 at the front of the transmission 100. As shown in FIG. 9, during operation, a blade assembly 950 is held within this cavity and extends out of the blade opening 121 such that the blade is exposed for use. To ensure stability and proper alignment of the blade assembly, the housing 110 and gearcase 130 include a set of alignment features such as locating pins 831a-d and rear rails 811a-b for assisting in placement of a blade assembly in an aligned position suitable for locking the blade assembly in operative engagement with the transmission 100. As used herein, the “aligned position” will be understood to refer to all configurations wherein the blade assembly 950 may be locked by the bottom cover 120 to extend out of the blade opening 121 and may be operatively engaged with the drive plate 832 to produce a cutting action. It will be understood that various additional or alternative alignment features may be employed to assist in placing the blade assembly 950 in the aligned position.

The locating pins 831a-d extend downwardly from the gearcase 130 in four locations positioned to be complementary with the geometric features of the blade assembly 950 such as, for example, being received within interior recesses of the blade assembly 950. As an example, FIG. 10 shows the blade assembly 950 in the aligned position with respect to the open transmission 800. The locating pins 831a-d are received through complementary pin holes 1051a-d. As such, the blade assembly 950 is held in the aligned position and may be removed only by first sliding the locating pins 831a-d out of engagement with the pin holes 1051a-d. Various alternative arrangements may be utilized. For example, fewer or additional locating pins may be provided, pin recesses that are not throughholes may be formed on the upper surface of the blade assembly 950 for receiving locating pins 931a-d, or one or more locating pins 831a-d may engage a partial pin hole that is formed in the outer edge of the blade assembly 950 such as one of the partial holes 1052a-b shown in FIG. 10.

As another example of an alignment feature, the rear rails 811a-b perform a secondary function. In addition to receiving the rail hooks of the bottom cover 120 for holding the bottom cover 120 in place, the rear rails 811a-b form an edge that is complementary to the rear edge of the blade assembly 950. As such, an operator may easily place the blade in the aligned position by abutting the read edge of the blade assembly 950 against the edge formed by the rear rails 811a-b and then lowering the blade assembly 950 onto the locating pins 831a-d. As shown in FIG. 10, additional back edges 1011a-b may project from the housing 110 between the rear rails 811a-b to provide additional area against which the blade assembly abuts. The back edges 1011a-b may form a hook that receives the back edge of the blade assembly 950 as shown, or may simply project downward to provide a backstop for the blade assembly 950. Various modifications may be apparent. In various embodiments, edges may be placed virtually anywhere on the lower surface of the housing 110 or gearcase 130 in a position that abuts the blade assembly 950 when occupying the aligned position. For example, projections may be arranged to form a full footprint that abuts every edge of the blade assembly that is received within the transmission 100 when in the aligned position.

While various alignment features have been described as facilitating placement of the blade assembly 950 in the proper aligned position with respect to the open transmission 800 prior to locking of the blade by the bottom cover 120, the blade may nonetheless move out of the aligned position prior to locking. For example, where the blade assembly 950 is sufficiently long and the open transmission 800 is held upside down for the operator to attach the bottom cover 120, the weight of the blade may cause the blade assembly 950 to pivot at the front edge of the housing and thereby move the back edge of the blade assembly 950 outward away from the transmision and out of engagement with the locating pins 831a-d, rear rails 811a-b, back edges 1011a-b, or other alignment features that may be employed in construction of the transmission. Possible movements out of the aligned position such as this may complicate the manual procedure necessary for the operator in locking the blade assembly in place.

To help counteract such movements out of the aligned position, the housing 110 carries a magnet assembly 840. The magnet assembly 840 carries a magnet that attracts the blade assembly toward the open transmission 800 and into alignment with the various alignment features 811a-b, 831a-d, 1011a-b employed. Thereafter, the magnet resists various forces that would work to move the blade assembly 950 out of the aligned position such as, for example, the force of gravity acting on the unsupported the blade assembly 950 when the open transmission 800 is held upside down. With the blade assembly 950 thus held in the aligned position, the process of reattaching the bottom cover 120 to the open transmission 800 is simplified because the operator need not manually hold the blade assembly 950 in place.

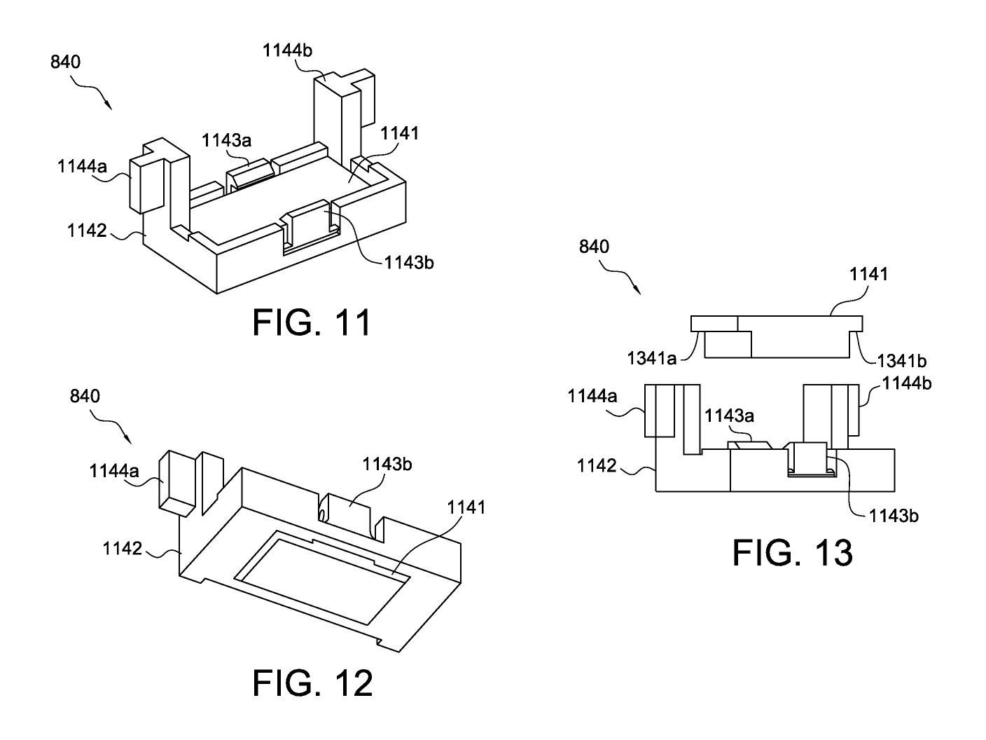

As shown in further detail in FIGS. 11-13, the exemplary magnet assembly 840 includes two components: a magnet 1141 and a magnet holder 1142. The magnet 1141 may be virtually any magnet sufficiently strong to provide at least some magnetic attraction to the blade assembly without interfering with the operation of the drive plate 832 or other moving metallic parts. In various embodiments, the magnet 1141 is a rare earth magnet.

The magnet holder 1142 is formed of plastic or other material as an open frame such that a bottom surface of the magnet 1141 is exposed on the underside of the magnet holder 1142, as is clearly seen in FIG. 12. In various embodiments the magnet 1141 is held proud beyond the lower surface of the magnet holder 1142. In other words, the bottom surface of the magnet 1141 may be positioned lower than the bottom surface of the magnet holder 1142. For example, magnet 1141 may be between 0.5 mm and 1.0 mm proud beyond the magnet holder 1142. To enable magnet proudness without the magnet 1141 falling through the frame of the magnet holder 1142, the magnet 1141 may be specially shaped with at least one magnet ledge 1341a-b, as may be seen in FIG. 13. More specifically, in the example of FIG. 13, the magnet 1141 increases in the width dimension moving from bottom to top to produce the two magnet ledges 1341a-b opposite each other. The magnet ledges 1341a-b engage the inner surface of the magnet holder 1142 to prevent passage of the magnet 1141 therethrough. Various modifications will be apparent. For example, magnet ledges may be provided on all four sides such that a single magnet ledge (not shown) encircles the magnet. As another alternative, the dimension increase may be gradual, such that the magnet ledge is a sloping face. In some such embodiments, the magnet holder 1142 may be provided with a complementary sloping interior face.

The magnet holder 1142 may include additional structures. As shown in FIG. 11, the magnet holder also includes two resilient snap tabs 1143a-b for holding the magnet 1141 in place in the magnet holder 1142. Various alternatives to snap tabs 1143a-b will be apparent. For example, the magnet 1141 may be held in place with adhesive, or the magnet holder 1142 may be closed by forming an additional surface of material on top of the magnet 1141.

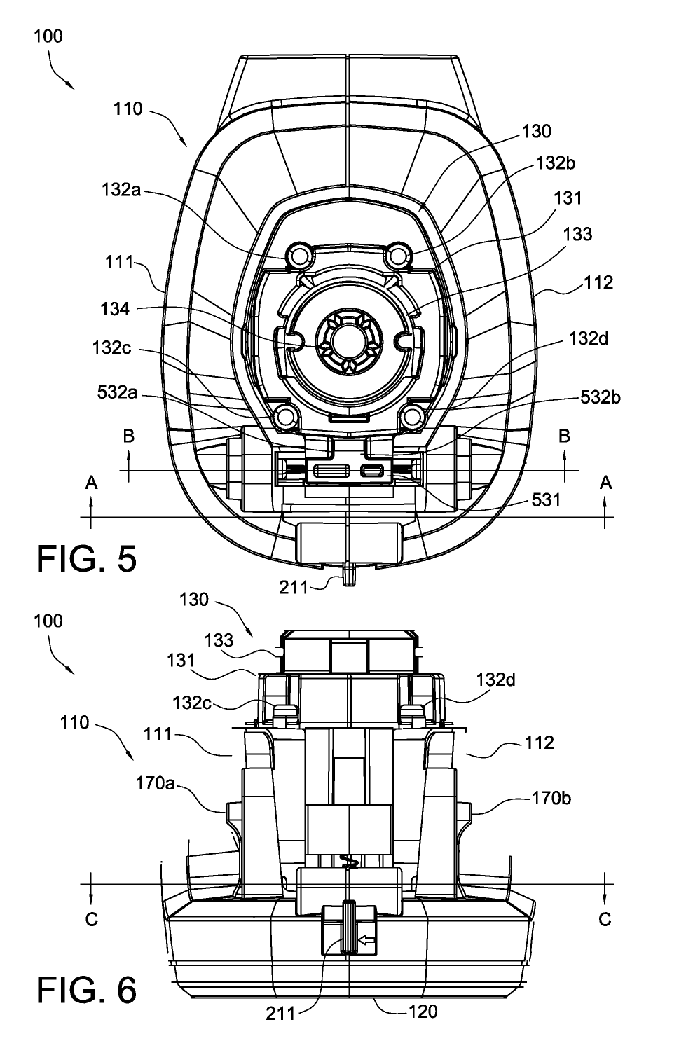

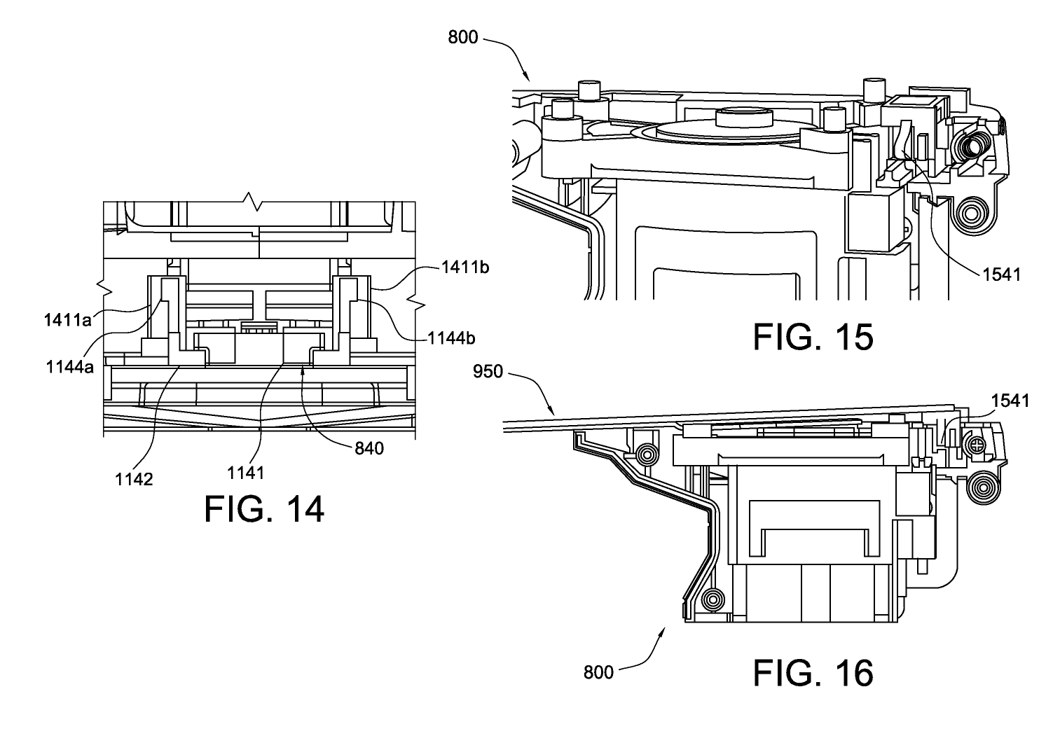

In various embodiments, the magnet assembly 840 may be movable with respect to the housing 110. For example, the magnet assembly 840 may be held in a free-floating arrangement with respect to the housing 110. To provide some degree of constraint to the movement allowed of the magnet assembly 840, a rail interface may be formed between the magnet assembly 840 and housing 110. As such, the magnet holder 1142 also includes two magnet holder rails 1144a-b. As can be seen in FIG. 14, which shows a cross section of the transmission 100 taken across line A-A of FIG. 5, the housing 110 includes two interior magnet holder rail slots 1411a-b which receive the magnet holder rails 1144a-b, respectively. Through this arrangement, the magnet assembly 840 is constrained to up and down movement. The magnet holder rail slots 1411a-b may also include closed ends and thereby prevent the magnet assembly 840 from being pulled out of engagement with the housing 110. In some such embodiments, the closed ends of the magnet holder rail slots 1411a-b may be positioned to allow the magnet assembly 840 to extend for some distance beyond the lower surface of the housing 110. As such, during attachment of the blade assembly 950 to the open housing 850, the magnet 1141 may extend outward a distance to meet the blade assembly 950, as can be seen in FIGS. 15-16. Then, as the blade assembly 950 is moved into full engagement with any alignment features, the magnet is pushed back into the housing. Such an arrangement is useful, for example, where the drive pin 832 is not yet aligned for engagement with a yoke of the blade assembly 950 and, as such, may not permit or may otherwise resist full engagement of the blade assembly 950 with the alignment features.

In various embodiments, the magnet assembly 840 may be adapted to further assist in pulling the blade assembly 950 into alignment with the alignment features, beyond what is already accomplished by the magnetic attraction. For example, the magnet assembly 840 may be spring biased to return to its initial position in the housing 110 after extending outward to meet the blade assembly 950. In some such embodiments and as can be seen in FIGS. 15-16, the magnet holder 1142 may be attached to for formed with one or more magnet holder springs 1541. As shown, the magnet holder spring 1541 is a flat spring that is positioned to compress as the magnet assembly 840 moves out of the housing 110 and thereby bias the magnet assembly 840 to move back into the housing 110. Various alternative arrangements for biasing the magnet assembly 840 to move into the housing 110 will be apparent.

Further, various alternative arrangements for mounting a magnet within the housing 110 will be apparent. For example, the magnet assembly 840 or just the magnet 1141 may be fixedly formed within or otherwise attached to the housing 110. In some such embodiments, the magnet 1141 may be configured to be proud below the lower surface of the housing 110 such as, for example, 0.5 mm to 1.0 mm proud.

Turning back to FIGS. 1-6, the gearcase 130 is partially disposed within the housing 110 and is arranged to transfer rotary motion imparted by a power unit 1760 (see FIG. 18) to the drive plate 832 arranged at the bottom of the housing 110 which, in turn, engages the blade assembly 950 to produce a cutting action. The gearcase 130 includes a gearcase cover 131 that is attached to the gearcase body via gearcase cover screws 132a-d. Near its top, the gearcase cover 131 forms a power unit interface 133 that is complementary to an engaging structure on a power unit. As shown in the examples of the figures, the power unit interface 133 may be an interface for adrill. However, it will be appreciated that various alternative power unit interfaces may be used for enabling use of the transmission 100 with other power units. The gearcase cover 131 also allows passage of a power unit coupler 134 from the interior of the gearcase 130. As will be explained in greater detail below, the power unit coupler 134 is structured to receive rotary motion imparted by an attached power unit.

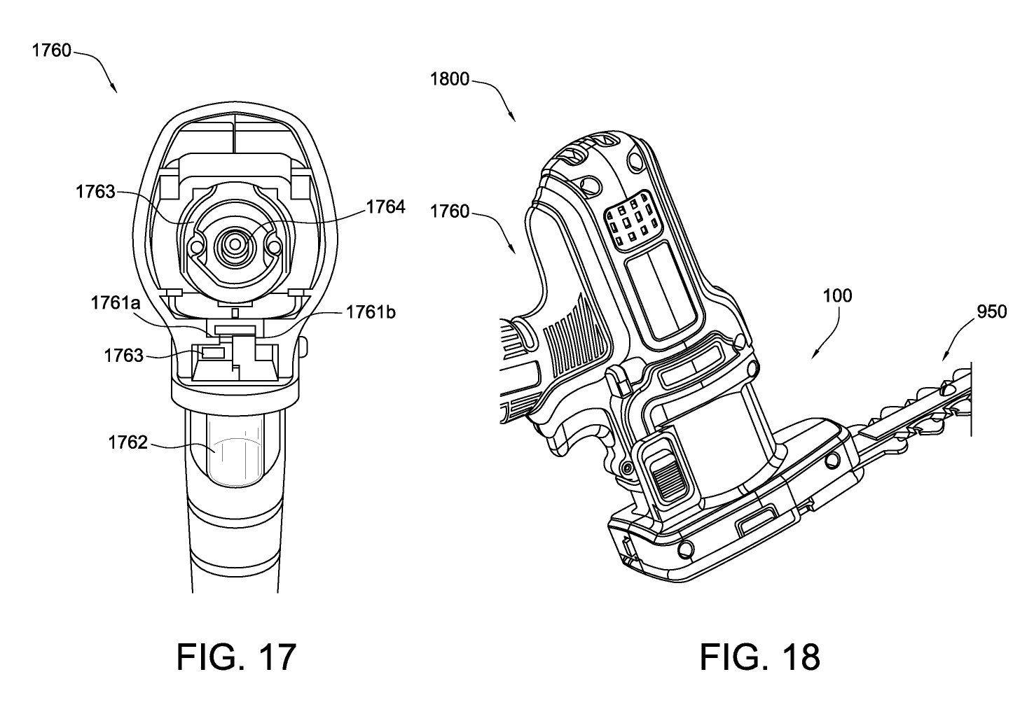

As shown in FIG. 17, the power unit 1760 may include multiple structures that are complementary to the transmission 100 such as a transmission interface 1763 structured to engage the power unit interface 133 and a transmission coupler 1764 structured to engage and impart rotary motion to the power unit coupler 134 during operation as part of the assembled power tool 1800 shown in FIG. 18. In various embodiments, the power unit 1760 may be a power unit of a drill. The power unit 1760 is also shown with two t-slot rails 1761-a-b that, when assembled with a transmission 100, engage two slots 532a-b formed by a t-slot piece 531 that extends from the rear of the gearcase 130, as can be seen in FIGS. 5-6.

In various embodiments, the power unit 1760 is provided with a safety feature to prevent unintentional or accidental activation of the power tool 1800. Specifically, the power unit 1760 may maintain the power unit trigger 1762 in a locked state until a safety button is pressed 1763. The safety button 1763 is positioned such that it is covered by the transmission 100 when the power tool 1800 is assembled and, as such, the safety button 1763 is not manually accessible. Instead, the transmission 100 is provided with structure for the user to indirectly press the safety button 1763 when operation of the power tool 1800 is desired. Specifically, the transmission 100 includes a left side lock button 170a and a right side lock button 170b, either of which may be slid away from the bottom cover 120 by the operator to press the safety button 1763 and thereby unlock the power unit trigger 1762 for operation of the power tool 1800.

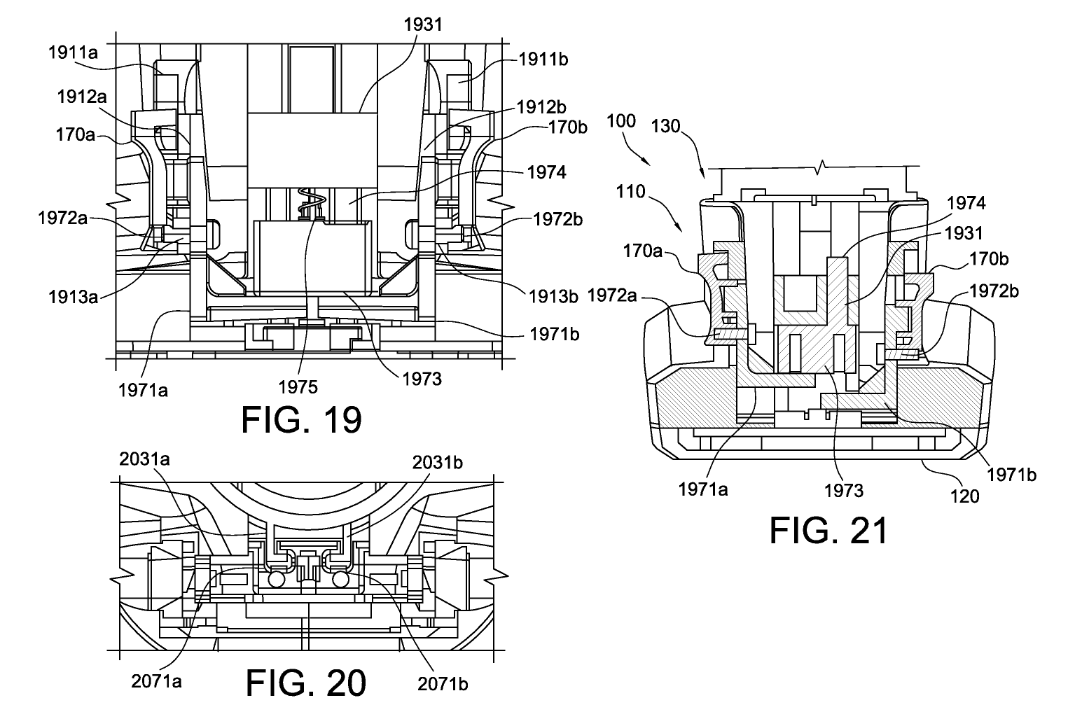

As can be best seen in the example of FIGS. 19-20, the lock buttons 170a-b are received within respective lock button tracks 1911a-b such that the lock buttons 170a-b may slide up and down with respect to the housing 110. Similarly, two L-shaped lock arms 1971a-b are received within respective lock arm tracks 1912a-b. A pair of lock screws 1972a-b attach respective lock arms 1971a-b to respective lock buttons 170a-b by extending through a respective slot-shaped lock screw passage 1913.a-b. The lock screw passages 1913a-b connect the lock button tracks 1911a to the associated lock arm tracks 1912a-b but are not wide enough to allow passage of the lock button 170a-b or lock arm 1971a-b therethrough.

The lock arms 1971 a-b both extend underneath a lock plate 1973 having an upwardly extending lock plate finger 1974. The lock plate finger 1974 is received within a t-slot piece channel 1931. The T-slot piece channel 1931 extends entirely through the t-slot piece 531 and is aligned with the safety button 1763 of the power unit 1760 when the power tool 1800 is assembled. The lock plate 1973 is movable up and down with respect to the housing 110 and gearcase 130 along gearcase rails 2013a-b. Specifically, as can be seen in the cross-section across line C-C, the lock plate 1973 includes two lock plate slots 2071a-b that receive the gearcase rails 2031a-b, respectively. The lock plate 1973 is downwardly biased by a lock plate spring 1975 that is disposed between the lock plate 1973 and the t-slot piece 531.

As illustrated in the cross section across line B-B in FIG. 21, when the operator wishes to begin use of the power tool 1800, the user slides one of the lock buttons 170a-b upward which also moves the attached lock arm 1971a-b upward. The lock arm 1971a-b, in turn, pushes the lock plate 1973 upward, such that the lock plate finger 1974 extends out of the t-slot piece channel 1931 and engages the safety button 1763 on the power unit 1760 to unlock the power unit trigger 1762. The operator may then, before releasing the lock button 170a-b, squeeze the power unit trigger 1762 to engage the motor and initiate operation of the device. Thereafter, the operator may release the lock button 170a-b. The lock plate spring 1975, no longer opposed by the operator holding the lock button 170a-b, pushes the lock plate 1973 downward, which pushes the raised lock arm 1971a-b and attached lock button 710a-b downward, back to the initial position. It will be appreciated that, because both lock arms 1971a-b are disposed underneath the same lock plate 1973, the operator may actuate either of the lock buttons 170a-b as convenient to unlock the power unit trigger 1762.

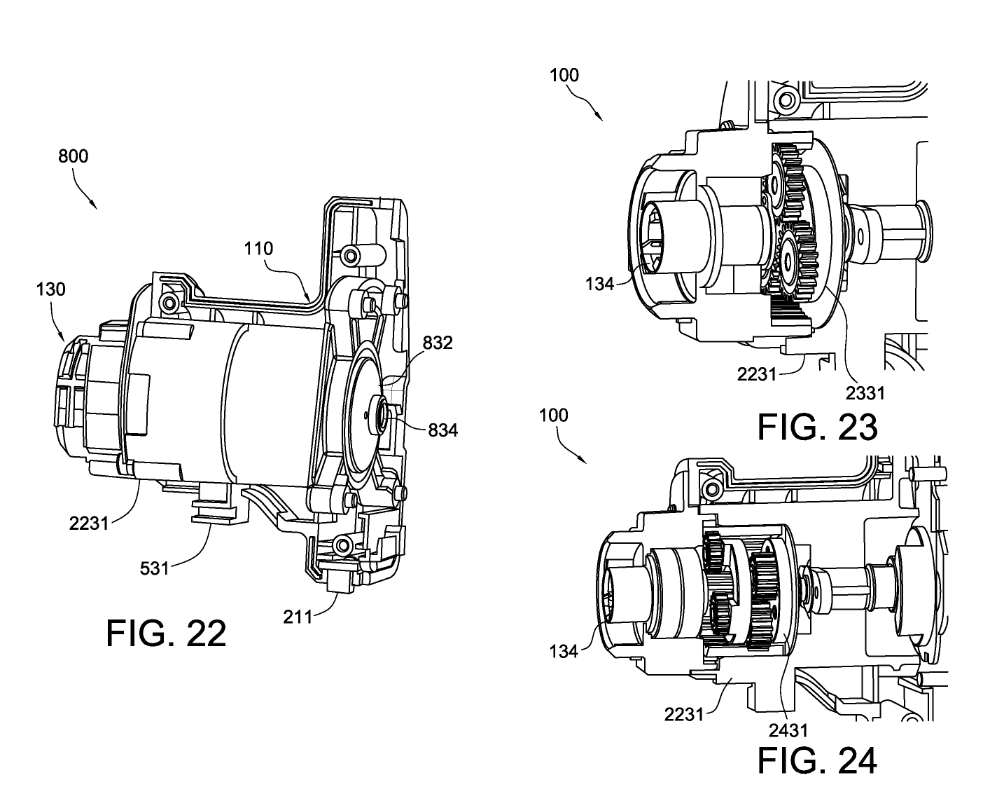

As seen in FIG. 22, the housing 110 encloses a gear case body 2231 that houses a gear set for translating rotary motion input by the power unit 1760 at the power unit coupler 134 into a cutting motion of the blade assembly 950 via the drive plate 832. Various gear sets may be used for such translation. For example, a single stage reduction gear set 2331 as shown in FIG. 23 or a dual stage reduction gear set 2431 as shown in FIG. 24 may be used. In various embodiments, the single stage reduction gear set 2331 or the two stages of the dual stage reduction gear set 2431 may each be planetary gear systems, the construction of which will be understood by those of skill in the art.

In various embodiments, the power unit 1760 may be configured to provide an input speed of about 28,000 RPM. In some embodiments, a gear set, such as the dual stage reduction gear set 2431, may have a gear ratio of 20:1 and may therefore provide an output speed of about 1,400 RPM to the drive plate 832 when attached to an 28,000 RPM input. In other embodiments, a gear set, such as the single stage reduction gear set 2331, may have a gear ratio of 10:1 and may therefore provide an output speed of about 2,800 RPM when attached to an 28,000 RPM input. It will be apparent that various alternative arrangements may be utilized to provide such output speeds. For example, the gear ratio of the single stage reduction gear set 2331, the dual stage reduction gear set 2431, or another alternative gear set (not shown) may be tuned to provide an output within the range of 2,000 to 3,200 RPM or within the range of 2,000 to 2,800 RPM.

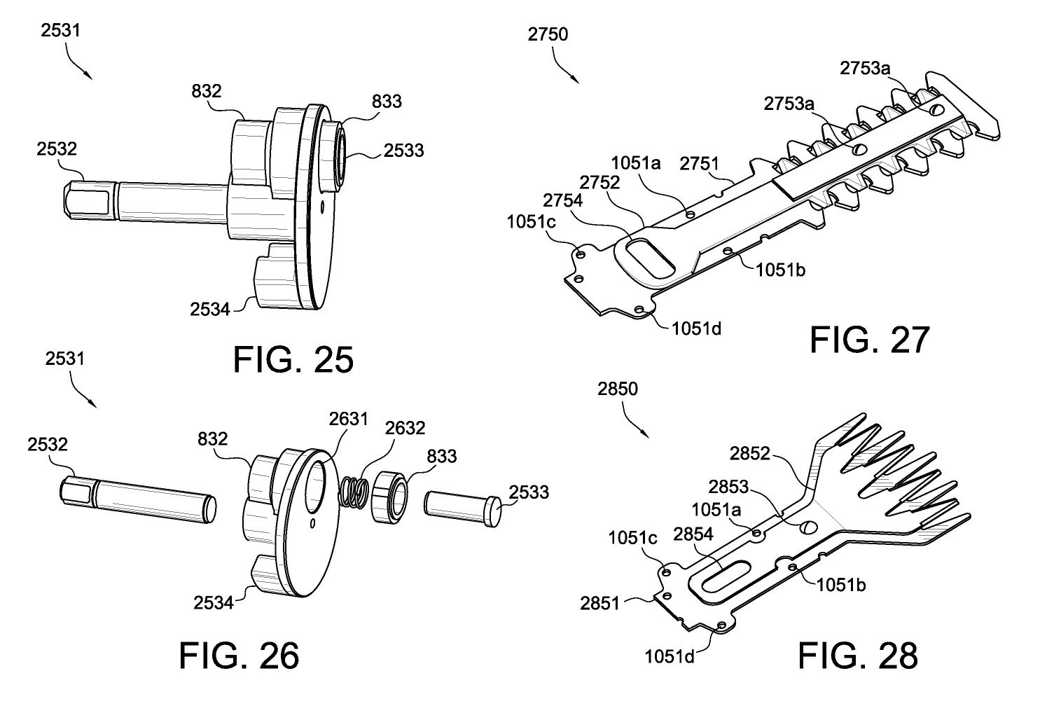

To enable high speed output, the gear set may connect to a specially balanced drive plate assembly 2531. As shown in FIGS. 25-26, the drive plate assembly 2531 includes a drive plate 832 attached to the end of a drive shaft 2532 that is rotated by the gear set. The drive plate 832 includes an off-center drive plate aperture 2631 sized to receive a drive spring 2632, a drive pin 833, and a headed drive pin 2533. The drive pin 833 and headed drive pin 2533 may be retracted, under force, within the drive plate aperture 2631 and, upon release of the force, will be moved back to the initial position by the drive spring 2632. To balance the drive plate 832, a drive plate counterweight 2534 is provided opposite the drive plate aperture 2631. The drive plate counterweight 2534 is of a mass selected to match or otherwise offset the mass added to the drive plate by the drive plate aperture 2631, drive spring 2632, drive pin 833, and headed drive pin 2533, thereby providing a more balanced drive plate assembly 2531 that may be operated at higher speeds.

Exemplary blade assemblies 2750, 2850 for use as a blade assembly 950 are detailed in FIGS. 27-28. For example, in FIG. 27, a single action shrub blade assembly 2750 is shown as including a stationary shrub blade 2751 slideably attached to a moving shrub blade 2752 via blade assembly rivets 2753a-b. The stationary shrub blade 2751 and moving shrub blade 2752 both include two rows of laterally extending teeth that cooperate to provide a cutting action. The moving shrub blade 2752 also includes a shrub yoke 2754 that receives the drive pin 833 of the drive plate assembly 2531. Due to the horizontal orientation of the shrub yoke 2754, the revolving motion of the drive pin 833 is translated to linear reciprocating motion of the moving shrub blade 2752 with respect to the stationary shrub blade 2751.

As another example, in FIG. 28, a single action shear blade assembly 2850 is shown as including a stationary shear blade 2851 pivotally attached to a moving shear blade 2752 via blade assembly rivet 2854. The stationary shear blade 2851 and moving shear blade 2852 both a row of forward extending teeth that cooperate to provide a cutting action. The moving shear blade 2852 also includes a shear yoke 2854 that receives the drive pin 833 of the drive plate assembly 2531. Due to the vertical orientation of the shear yoke 2854, the revolving motion of the drive pin 833 is translated to pivotal reciprocating motion of the moving shear blade 2852 with respect to the stationary shear blade 2851.

It will be appreciated that the rear portions of the stationary shrub blade 2751 and stationary shear blade 2851 are provided with similar or identical geometric features such as similarly shaped outer edges and similarly positioned pin holes 1051a-d. As such, the two blade assemblies 2750, 2850 may be interchangeably attached to the transmission 100 as desired by the operator. It will be apparent that enabling attachment of additional blade assembles may be similarly achieved by providing similar or identical geometric features for cooperation with alignment features on the transmission 100.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A hand-held power tool with a removable blade comprising:
a housing;
a selectively actuable motor including a rotary output;
a rotary drive element arranged in operative contact with the rotary output of the motor and including a drive pin;
a removable blade assembly having a stationary blade and a moving blade in operative contact with the drive pin, wherein movement of the drive pin is translated into movement of the moving blade;
a blade holder operable to selectively lock the stationary blade in an aligned position with respect to the housing; and
a magnet positioned to contact the stationary blade when the stationary blade occupies the aligned position and hold the stationary blade in the aligned position.

2. The power tool of claim 1, wherein the magnet is movable with respect to the housing such that during attachment of the removable blade assembly to the housing, the magnet is permitted to extend toward the stationary blade under the force of magnetic attraction, away from an initial magnet position occupied by the magnet when the blade holder locks the stationary blade.

3. The power tool of claim 2, wherein the magnet is spring biased to return to the initial magnet position.

4. The power tool of claim 1, further comprising:
a magnet holder comprising an open frame configured to receive the magnet such that the magnet is exposed on at least one side of the frame.

5. The power tool of claim 4, wherein the magnet includes at least one ledge created by an increase in at least one dimension of the magnet, wherein the at least one step is positioned to abut an interior face of the open frame and thereby resist passage of the magnet through the frame.

6. The power tool of claim 4, wherein the magnet is at least 0.5 millimeters proud with respect to a blade-facing side of the open frame.

7. The power tool of claim 1, further comprising an alignment feature matching a geometric feature of the removable blade assembly and the magnet at least partially pulls the stationary blade toward alignment with the alignment feature during attachment of the removable blade assembly to the housing.

8. The power tool of claim 7, wherein the alignment feature comprises at least one edge having a shape that is complementary to a portion of an outer edge of the removable blade assembly.

9. The power tool of claim 8, wherein the blade holder is a removable cover and the at least one edge is a portion of a rail arranged to mate with a complementary hook of the removable cover.

10. The power tool of claim 7, wherein the alignment feature comprises at least one projection having a shape that is received within an interior recess disposed within the removable blade assembly.

11. The power tool of claim 1, wherein the blade holder comprises a removable cover configured to mate with the housing, wherein when the cover is mated with the housing while the blade in the aligned position, the blade is disposed between the cover and the housing and is prevented from moving out of the aligned position.

12. A power tool transmission comprising:
a housing;
an interface operable to engage a rotary output of a motor;
a gearbox operatively connected to the interface to transfer the rotary output to a drive plate including a drive pin;
a blade holder operable to selectively lock a stationary blade of a removable blade assembly in an aligned position with respect to the housing; and
a magnet positioned to contact the stationary blade when the stationary blade occupies the aligned position.

13. The power tool transmission of claim 12, wherein the magnet is movable with respect to the housing such that during attachment of the removable blade assembly to the housing, the magnet is permitted to extend toward the stationary blade under the force of magnetic attraction, away from an initial magnet position occupied by the magnet when of blade holder locks the stationary blade.

14. The power tool transmission of claim 13, wherein the magnet is spring biased to return to the initial magnet position.

15. The power tool transmission of claim 12, further comprising:
a magnet holder comprising an open frame configured to receive the magnet such that the magnet is exposed on at least one side of the frame.

16. The power tool transmission of claim 15, wherein the magnet includes at least one ledge created by an increase in at least one dimension of the magnet, wherein the at least one step is positioned to abut an interior face of the open frame and thereby resist passage of the magnet through the frame.

17. The power tool transmission of claim 15, wherein the magnet is at least 0.5 millimeters proud with respect to a blade-facing side of the open frame.

18. The power tool transmission of claim 12, further comprising at least one alignment feature matching a geometric feature of the removable blade assembly and the magnet at least partially pulls the stationary blade toward alignment with the alignment feature during attachment of the removable blade assembly to the housing.

19. The power tool transmission of claim 18, wherein the alignment feature comprises at least one edge having a shape that is complementary to a portion of an outer edge of the removable blade assembly.

20. The power tool transmission of claim 19, wherein the blade holder is a removable cover and the at least one edge is a portion of a rail arranged to mate with a complementary hook of the blade cover.

21. The power tool transmission of claim 18, wherein the alignment feature comprises at least one projection having a shape that is received within an interior recess disposed within the removable blade assembly.

22. The power tool transmission of claim 12, wherein the blade holder comprises a cover configured to mate with the housing, wherein when the cover is mated with the housing while the blade in the aligned position, the blade is disposed between the cover and the housing and is prevented from leaving the aligned position.
